(19) United States
(12) Patent Application Publication
(10) Pub. No.: US 2011/0173407 A1
(43) Pub. Date: Jul. 14, 2011

(54) DATA STORAGE SYSTEM

(75) Inventors: Andrew Topham, Dursley Gloucestershire (GB); Alastair Slater, Chepstow Monmouthshire (GB); Matthew Jack Burbridge, Bristol (GB)

(73) Assignee: HEWLETT-PACKARD DEVELOPMENT COMPANY, L.P., Houston, TX (US)

(21) Appl. No.: 11/669,908

(22) Filed: Jan. 31, 2007

(30) Foreign Application Priority Data
Jul. 28, 2006 (GB) 0615018.9

(51) Int. Cl. G06F 12/14

(52) U.S. Cl. 711/163; 711/E12.093

(57) ABSTRACT

A data storage system comprising a server computer and a data storage medium. The server computer includes an interface, such as an iSCSI interface, for communicating with a host computer. In response to receiving data from the host computer, the server computer determines whether or not the host computer has access to a virtual data storage device. If the host computer does not have access to a virtual data storage device, the server computer provides a virtual data storage device for access by the host computer, the virtual data storage device employing at least a portion of the data storage medium such that data stored to the virtual data storage device are stored to the portion of the data storage medium.

### FIELD OF THE INVENTION

The present invention relates to a data storage system that provides, in response to data received from a host computer, a virtual data storage device for access by the host computer.

### BACKGROUND OF THE INVENTION

In a virtual tape (VT) system, one or more tape drives or tape libraries are emulated by a server that employs disks, rather than tape, as the storage media. Data are then stored to VT cartridges created by the server on the disks. Importantly, the VT system presents an interface that is indistinguishable from a conventional tape drive. Consequently, existing tape backup methods and software may be used, whilst the use of non-sequential storage media significantly reduces the time taken to backup and recover data. Additionally, data from a number of networked computers may be managed by a single VT system, which may be located more conveniently than a corresponding tape library. Data stored on VT cartridges may be subsequently transferred to physical tape cartridges for offsite data vaulting.

A VT system typically emulates multiple VT devices. Each VT device consists of a VT drive and VT cartridges or a VT library, the VT library comprising VT drives, virtual racks having slots that house VT cartridges, and virtual robot pickers for transferring the VT cartridges between the virtual racks and the VT drives. Conventional VT systems may be provided preconfigured with a fixed number of VT devices. Alternatively, VT systems may be provided unconfigured with no VT devices. A user is then required to create and configure the VT devices of the VT system.

For unconfigured VT systems, a user will typically create a VT device for each computer that requires access to a tape drive. Once the VT devices have been created, the user must then set the access rights for each VT device so that only the intended computer has access to the VT device. The manual configuration of a VT system is generally time consuming and prone to errors. In particular, the access rights for a VT device may be configured wrongly such that the VT device is accessible by the wrong computer.

### SUMMARY OF THE INVENTION

In a first aspect, the present invention provides a data storage system comprising a server computer and a data storage medium, wherein the server computer includes an interface for communicating with a host computer and is operable to: receive data from the host computer; determine, in response to receiving the data, whether the host computer has access to a virtual data storage device; and provide a virtual data storage device for access by the host computer in the event that the host computer does not have access to a virtual data storage device, the virtual data storage device employing at least a portion of the data storage medium such that data stored to the virtual data storage device are stored to the portion of the data storage medium.

Preferably, the data received from the host computer includes identification information that uniquely identifies the host computer, and the server computer is operable to determine, using the identification information, whether the host computer has access to a virtual data storage device.

Advantageously, the server computer includes a database storing a list of virtual data storage devices provided by the server computer and a list of host computers having access to the virtual data storage devices, and the server computer is operable to determine whether the host computer has access to a virtual data storage device by comparing the identification information against the list of host computers.

Conveniently, the identification information comprises at least one of an iSCSI name and an IP address.

Preferably, the server computer is operable to determine whether the host computer has access to a virtual data storage device in response to receiving data that includes a request for the identities of accessible devices to be returned to host computer.

Advantageously, the server computer is operable to determine whether the host computer has access to a virtual data storage device in response to receiving data that includes an iSCSI SendTargets command or a SCSI ReportLUNs command.

Conveniently, the server computer is operable to: determine if the number of virtual data storage devices provided by the server computer has reached a predetermined limit; and provide the virtual data storage device for access by the host computer in the event that the number of virtual data storage devices provided by the server computer has not reached the predetermined limit.

Preferably, in the event that the number of virtual data storage devices provided by the server computer has reached the predetermined limit, the server computer returns to the host computer a response indicating that no virtual data storage devices are accessible.

Advantageously, the server computer is operable to provide virtual tape devices, each virtual tape device comprising at least one virtual tape drive and at least one virtual tape cartridge.

Conveniently, the server computer is operable to return to the host computer the identity of each virtual data storage device to which the host computer has access.

Preferably, a virtual data storage device comprises one or more target devices and the server computer returns to the host computer the identity of each target device of each virtual data storage device to which the host computer has access.

Advantageously, the data storage medium is provided by one or more data storage items, each data storage item comprising a data storage medium suitable for non-sequential access.

In a second aspect, the present invention provides a data storage system comprising a server computer and a data storage medium, wherein the server computer comprises: means for receiving data from a host computer; means for determining, in response to receiving the data, whether the host computer has access to a virtual data storage device; and means for emulating a virtual data storage device for access by the host computer in the event that the host computer does not have access to a virtual data storage device, the virtual data storage device employing at least a portion of the data storage medium such that data stored to the virtual data storage device are stored to the portion of the data storage medium.

In a third aspect, the present invention provides a server computer for emulating one or more virtual data storage devices, the server computer having an interface for communicating with a host computer and an interface for communicating with a data storage item, the data storage item comprising a data storage medium and the server computer being operable to: receive data from the host computer; determine, in response to receiving the data, whether the host computer has access to a virtual data storage device; and provide a virtual data storage device for access by the host computer in the event that the host computer does not have access to a virtual data storage device, the virtual data storage device employing at least a portion of the data storage medium provided by the data storage item such that data stored to the virtual data storage device are stored to the portion of the data storage medium.

In a fourth aspect, the present invention provides a server computer for emulating one or more virtual data storage devices, the server computer comprising: means for writing data to and reading data from a data storage medium; means for receiving data from a host computer; means for determining, in response to receiving the data, whether the host computer has access to a virtual data storage device; and means for emulating a virtual data storage device for access by the host computer in the event that the host computer does not have access to a virtual data storage device, the virtual data storage device employing at least a portion of the data storage medium such that data stored to the virtual data storage device are stored to the portion of the data storage medium.

In a fifth aspect, the present invention provides a computer program product storing computer program code executable by a server computer, the server computer having an interface for communicating with a host computer and an interface for communicating with a data storage item, the data storage item comprising a data storage medium, wherein the computer program code when executed causes the server computer to: receive data from the host computer; determine, in response to receiving the data, whether the host computer has access to a virtual data storage device; and provide a virtual data storage device for access by the host computer in the event that the host computer does not have access to a virtual data storage device, the virtual data storage device employing at least a portion of the data storage medium provided by the data storage item such that data stored to the virtual data storage device are stored to the portion of the data storage medium.

### BRIEF DESCRIPTION OF THE DRAWINGS

In order that the present invention may be more readily understood, embodiments thereof will now be described, by way of example, with reference to the accompanying drawings, in which:

FIG. 1 illustrates a virtual tape system embodying the present invention in a network environment;

FIG. 2 illustrates an alternative representation of the virtual tape system of FIG. 1 in which virtual tape devices, as emulated by the virtual tape system, are shown;

FIG. 3 illustrates an example of an initiator-access database employed by the virtual tape system of FIG. 1; and

FIG. 4 illustrates a flow diagram of the method of operation employed by the virtual tape system of FIG. 1.

### DETAILED DESCRIPTION

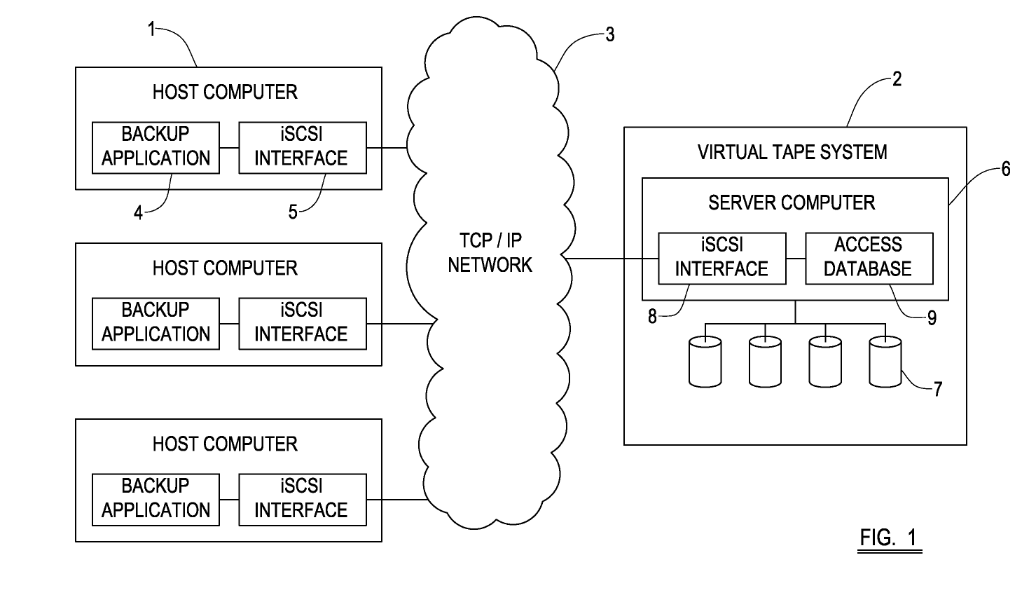

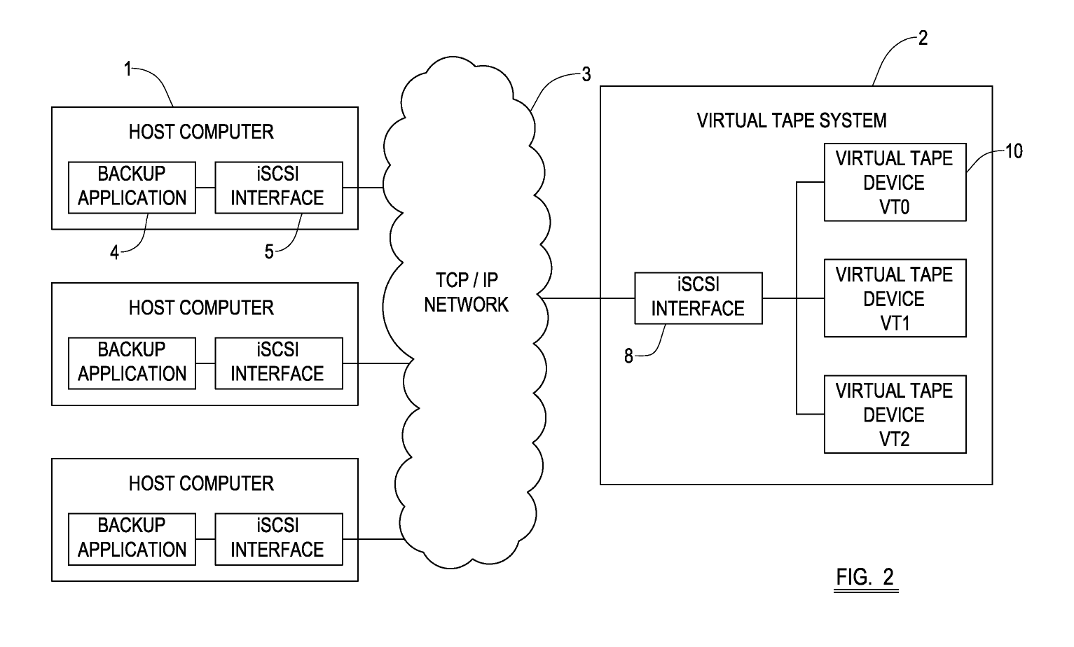

In FIGS. 1 and 2, several host computers 1 are connected to a virtual tape (VT) system 2 by means of a TCP/IP network 3.

Each host computer 1 executes a backup application 4, or other software/hardware application, that requires access to a SCSI tape device. Each host computer 1 is provided with an iSCSI interface 5 for sending and receiving data packets to and from the VT system 2 via the network 3.

The VT system 2 includes a sever computer 6 coupled to one or more disk drives 7, typically configured into one or more RAID arrays. The server computer 6 includes an iSCSI interface 8 for sending and receiving data packets to and from the host computers 1.

The server computer 6 is operable to emulate one or more VT devices 10. Each VT device 10 emulated by the server computer 6 comprises at least a VT drive and a VT cartridge. Optionally, a VT device 10 may comprise a VT library, the VT library comprising a VT library controller, one or more VT drives, one or more virtual racks housing VT cartridges and one or more virtual robot pickers for transferring the VT cartridges between the virtual racks and the VT drives.

Each VT device 10 is allocated a portion of the disk space provided by the disk drives 7. The portion allocated will depend upon the number and type of VT cartridges that the VT device 10 comprises. The portion of disk space allocated for each VT device 10 may be dynamic such that efficient use is made of the available disk space of the disk drives 7. Data stored on a VT device 10 is then stored on the allocated portion of the disk drives 7.

In iSCSI communications, the host computers 1 and the VT system 2 are each referred to as iSCSI nodes. The host computers 1 initiate iSCSI transactions whenever access to the VT system 2 is required and are consequently referred to as iSCSI initiators. The VT system 2 is the target of the iSCSI transactions and is consequently referred to as an iSCSI target.

Each iSCSI node (i.e. initiator or target) has a unique iSCSI name that uniquely identifies the iSCSI node irrespective of its physical location. Additionally, each iSCSI node has a unique IP address.

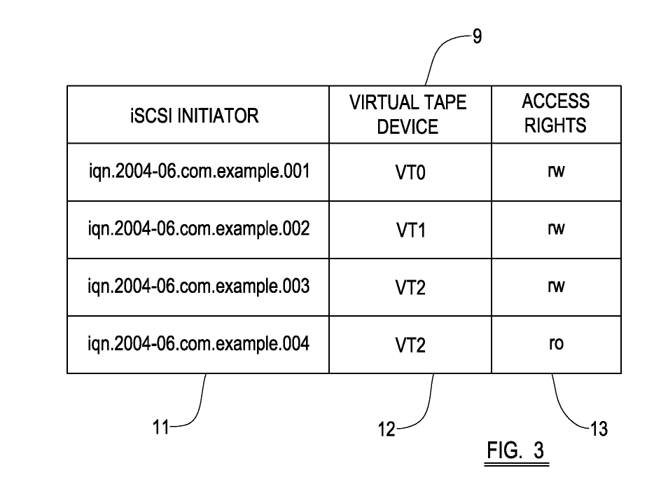

The server computer 6 includes an initiator-access database 9. Each VT device 10 emulated by the server computer 6 is accessible by one or more iSCSI initiators (e.g. host computers 1) according to the access rights provided by the initiator-access database 9. As illustrated in FIG. 3, each entry in the initiator-access database 9 comprises at least two data fields 11,12. The first data field 11 is the ISCSI name of an iSCSI initiator that has access rights to the VT system 2. The second data field 12 identifies the VT device 10, emulated by the server computer 6, to which the iSCSI initiator has access. For example, in FIG. 3, the iSCSI initiator having the name iqn.2004-06.com.example.001 has access to the VT device labelled VT1.

Generally speaking, each VT device 10 is accessible by a single iSCSI initiator. However, a VT device 10 may be accessible by more than one iSCSI initiator. For example, in FIG. 3, the VT device labelled VT2 is accessible by two iSCSI initiators having different iSCSI names.

Each entry in the initiator-access database 9 may additionally include a third data field 13 which stipulates the access rights that an iSCSI initiator has to a corresponding VT device 10. Accordingly, a particular iSCSI initiator may have restricted access rights (e.g. read-only access) to a particular VT device 10.

The total number of VT devices 10 that the VT system 2 is capable of supporting is limited to MAX_VT_DEVICES, which is a predetermined limit set according to the resources of the VT system 2, in particular the capacity of the disk drives 7.

The VT system 2 is initially provided with no VT devices 10 and the initiator-access database 9 is initially empty. The server computer 6 is then operable to create (i.e. emulate) VT devices in response to data packets received from iSCSI initiators, as described in further detail below. The server computer 6 may additionally permit VT devices 10 to be created and/or for the initiator-access database 9 to be modified manually, e.g. by means of a user interface connected to the server computer, or by instructions received over the TCP/IP network 3. In this way, VT devices 10 may be created and/or configured for access by more than one iSCSI initiator.

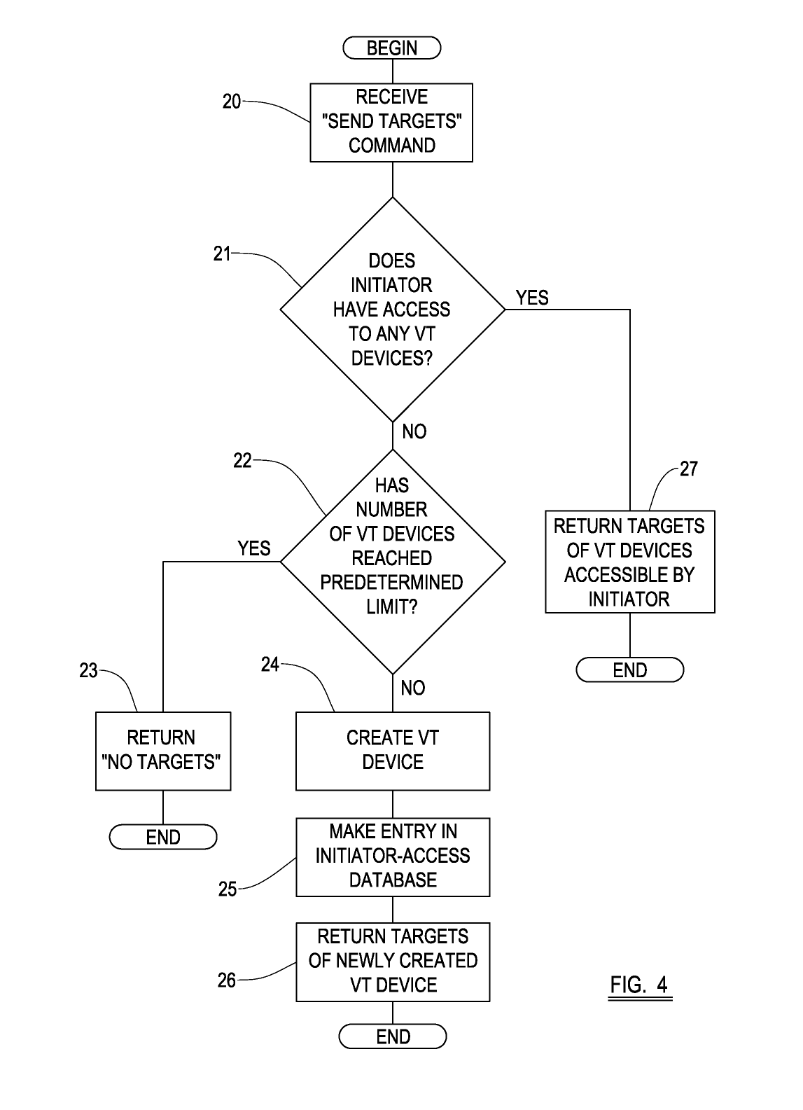

Referring now to FIG. 4, the server computer is operable to receive 20 a TCP/IP data packet from an iSCSI initiator (e.g. a host computer 1). The data packet carries a “SendTargets” command, which is issued by an iSCSI initiator prior to a session being opened. The iSCSI initiator then uses the response to the “SendTargets” command to determine what targets, if any, are accessible to the iSCSI initiator.

In response to the “SendTargets” command, the server computer 6 determines 21 whether the iSCSI initiator has access to any of the VT devices 10 emulated by the VT system 2. The server computer 6 makes this determination by comparing the iSCSI name encapsulated in the received data packet with the iSCSI names listed in the initiator-access database 9. If the iSCSI name of the data packet is found within the initiator-access database 9, the server computer 6 determines that the iSCSI initiator has access to one or more VT devices 10. Otherwise, the server computer 6 determines that the iSCSI initiator does not have access to any of the VT devices 10.

If the server computer 6 determines 21 that the iSCSI initiator does not have access to any of the VT devices 10, the server computer 6 determines 22 whether the number of VT devices 10 emulated by the server computer 6 has reached the predetermined limit of MAX_VT_DEVICES.

If the predetermined limit of MAX_VT_DEVICES has been reached, the server computer 6 responds to the “SendTargets” command by returning 23 to the iSCSI initiator a reply that indicates that there are no targets accessible to the iSCSI target.

If the predetermined limit on the number of VT devices has not been reached, the server computer 6 creates 24 (i.e. emulates) a VT device 10 using conventional VT emulation methods. The server computer 6 is configured to create a default type of VT device, which is chosen such that the VT system 2 is able to successfully emulate the predetermined limit of MAX_VT_DEVICES without any significant drop-off in performance, whilst at the same time each VT device offers a good range of facilities. By way of example only, the default VT device may comprise a single VT drive and eight VT cartridges, which permit a large degree of flexibility in scheduling backup jobs whilst being reasonably efficient in terms of VT system resources.

Rather than creating a default type of VT device, the type of VT device 10 created by the server computer 6 may be determined by other factors. For example, a different type of VT device 10 may be created for iSCSI initiators that belong to a particular network domain, as identified by the iSCSI name. Alternatively, the server computer 6 may dynamically allocate disk space to each VT device 10 such that, for example, each VT device 10 originally begins with only four VT cartridges and the number of VT cartridges is increased during subsequent use of the VT device 10, if required.

After the VT device 10 has been created, the sever computer 6 makes 25 an entry in the initiator-access database 9. The entry includes the iSCSI name of the iSCSI initiator and the identity of the newly created VT device 10.

Finally, the server computer 6 responds to the “SendTargets” command by returning 26 to the iSCSI initiator information (e.g. a list of iSCSI names) that identities each target of the newly created VT device that is accessible to the iSCSI initiator. In this regard, it is to be noted that the newly created VT device may comprise more than one target. For example, a virtual autochanger may include a first target for the VT drive and a second target for the virtual robot picker.

The server computer 6 may, by default, create more than one VT device 10 for each new iSCSI initiator. In this instance, the information returned 26 by the server computer 6 to the iSCSI initiator identifies each target of each newly created VT device.

If the server computer 6 determines 21 that the iSCSI initiator has access to one or more VT devices 10, the server computer 6 in response to the “SendTargets” command returns 27 to the iSCSI initiator information that identifies each of the targets the VT devices 10 to which the iSCSI initiator has access, as identified by the access-initiator database 9.

In the embodiment described above, the initiator-access database 9 stores the iSCSI name of each iSCSI initiator that has access rights to the VT system 2. Identifying an iSCSI initiator by means of the iSCSI name has the advantage that the iSCSI name uniquely identifies an iSCSI initiator irrespective of its physical location. Consequently, should a particular iSCSI initiator be allocated a different IP address (e.g. as a consequence of a local firewall or as a result of moving the iSCSI initiator to a different network segment), the iSCSI initiator will continue to be correctly identified by the server computer 6. Nevertheless, the initiator-access database 9 may alternatively, or additionally, store alternative information that uniquely identifies an iSCSI initiator and which is included in data packets received by the server computer, e.g. the IP address of the iSCSI initiator.

Whilst the server computer 6 determines 21 whether an iSCSI initiator has access to a VT device 10 in response to a “SendTargets” command, the server computer 6 may additionally or alternatively determine whether an iSCSI initiator has access to a VT device 10 in response to alternative information carried in data packets. This is particularly true when a data interface other than iSCSI is employed by the server computer 6. By way of example only, each TCP/IP data packet includes the source IP address in the header of the data packet. Accordingly, the server computer 6 in response to receiving a data packet over the TCP/IP network 3 may determine 21 whether the source of the data packet has access to a VT device 10 by comparing the source IP address of the TCP/IP packet with IP addresses listed in the initiator-access database 9. By way of an additional example, the server computer 6 may determine 21 whether an initiator has access to a VT device 10 in response to a SCSI command rather than an iSCSI command. In particular, the server computer 6 may determine 21 whether an initiator has access to a VT device 10 in response to a “ReportLUNs” command. The server computer 6, in response to the “ReportLUNs” command, returns 23,26,27 to the initiator information that identifies each of the logical units of the VT devices 10 to which the initiator has access.

Whilst reference has thus far been made to a VT system that employs magnetic disks as the data storage media, it will be appreciated that the invention is equally applicable to other forms of virtual data storage. For example, the virtual data storage system may emulate, or indeed employ as the data storage media, optical data storage items, such as CDs or DVDs. Alternatively, the virtual data storage system may emulate hard disks for access by iSCSI initiators.

In the embodiments described above, the VT system employs iSCSI as the data interface. However, other types of data interface may alternatively be employed, so long as the source of data received by the VT system can be uniquely identified. Suitable alternatives include, but are not limited to, FCIP and iFCP.

With the data storage system of the present invention, a virtual data storage device may be provided on-demand for access by a host computer. In particular, a virtual data storage device is provided (i.e. emulated) in response to communications received from a host computer that has not previously accessed the virtual data storage device. Consequently, virtual data storage devices may be created and access rights configured without requiring any user involvement.

A virtual data storage device should be understood to be any computer application, implemented in software and/or hardware, that emulates the operation of a physical data storage device such that the computer application presents an interface that is indistinguishable from the interface of the physical data storage device.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. A data storage system comprising a server computer and a data storage medium, wherein the server computer includes an interface for communicating with a host computer and is operable to:
receive data from the host computer;
determine, in response to receiving the data, whether the host computer has access to a virtual data storage device; and
provide a virtual data storage device for access by the host computer in the event that the host computer does not have access to a virtual data storage device, the virtual data storage device employing at least a portion of the data storage medium such that data stored to the virtual data storage device are stored to the portion of the data storage medium.

2. A data storage system according to claim 1, wherein the data received from the host computer includes identification information that uniquely identifies the host computer, and the server computer is operable to determine, using the identification information, whether the host computer has access to a virtual data storage device.

3. A data storage system according to claim 2, wherein the server computer includes a database storing a list of virtual data storage devices provided by the server computer and a list of host computers having access to the virtual data storage devices, and the server computer is operable to determine whether the host computer has access to a virtual data storage device by comparing the identification information against the list of host computers.

4. A data storage system according to claim 2, wherein the identification information comprises at least one of an iSCSI name and an IP address.

5. A data storage system according to claim 1, wherein the server computer is operable to determine whether the host computer has access to a virtual data storage device in response to receiving data that includes a request for identities of accessible devices to be returned to the host computer.

6. A data storage system according to claim 5, wherein the server computer is operable to determine whether the host computer has access to a virtual data storage device in response to receiving data that includes an iSCSI
SendTargets command or a SCSI ReportLUNs command.

7. A data storage system according to claim 1, wherein the server computer is operable to:
determine if the number of virtual data storage devices provided by the server computer has reached a predetermined limit; and
provide the virtual data storage device for access by the host computer in the event that the number of virtual data storage devices provided by the server computer has not reached the predetermined limit.

8. A data storage system according to claim 7, wherein, in the event that the number of virtual data storage devices provided by the server computer has reached the predetermined limit, the server computer returns to the host computer a response indicating that no virtual data storage devices are accessible.

9. A data storage system according to claim 1, wherein the server computer is operable to return to the host computer the identity of each virtual data storage device to which the host computer has access.

10. A data storage system according to claim 9, wherein a virtual data storage device comprises one or more target devices and the server computer returns to the host computer the identity of each target device of each virtual data storage device to which the host computer has access.

11. A data storage system according to claim 1, wherein the virtual data storage device emulates the operation of a physical data storage device and presents an interface to the host computer that is indistinguishable from the interface of the physical data storage device.

12. A data storage system according to claim 1, wherein the server computer is operable to provide virtual tape devices, each virtual tape device comprising at least one virtual tape drive and at least one virtual tape cartridge.

13. A data storage system according to claim 1, wherein the data storage medium is provided by one or more data storage items, each data storage item comprising a data storage medium suitable for non-sequential access.

14. A data storage system comprising a server computer and a data storage medium, wherein the server computer comprises:
means for receiving data from a host computer;
means for determining, in response to receiving the data, whether the host computer has access to a virtual data storage device; and
means for emulating a virtual data storage device for access by the host computer in the event that the host computer does not have access to a virtual data storage device, the virtual data storage device employing at least a portion of the data storage medium such that data stored to the virtual data storage device are stored to the portion of the data storage medium.

15. A computer program product storing computer program code executable by a server computer, the server computer having an interface for communicating with a host computer and an interface for communicating with a data storage item, the data storage item comprising a data storage medium, wherein the computer program code when executed causes the server computer to:
receive data from the host computer;
determine, in response to receiving the data, whether the host computer has access to a virtual data storage device; and
provide a virtual data storage device for access by the host computer in the event that the host computer does not have access to a virtual data storage device, the virtual data storage device employing at least a portion of the data storage medium provided by the data storage item such that data stored to the virtual data storage device are stored to the portion of the data storage medium.
